(19) United States
(12) Patent Application Publication
(10) Pub. No.: US 2007/0168736 A1
(43) Pub. Date: Jul. 19, 2007

(54) Breakpoint groups

(76) Inventors: Robert P. Ottavi, Brookline, NH (US); Richard D. Muratori, Stow, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/313,090

(22) Filed: Dec. 19, 2005

(51) Int. Cl. G06F 11/00

(52) U.S. Cl. 714/34

(57) ABSTRACT

A method and software architecture for grouping breakpoints. A plurality of breakpoints for halting execution of a program are created. A breakpoint group for logically associating one or more of the breakpoints is created. A portion of the breakpoints is added to the breakpoint group. The portion of the breakpoints is collectively enabled prior to executing the program by asserting an enable group command associated with the breakpoint group.

### TECHNICAL FIELD

This disclosure relates generally to software, and in particular but not exclusively, relates to logically grouping breakpoints for software debugging.

### BACKGROUND INFORMATION

To test, debug, and/or develop a software program for execution on a processing system, it is often desired to be able to stop the processor's execution of instructions at a specific place in the software program using a breakpoint. Typically, a breakpoint is inserted at a location that is of some significance to the program and/or machine executing the program. The program is then executed and a debugger tool used to examine the program's behavior. When the breakpoint is reached during the runtime, control is returned to the user, so that the user can single-step forward execution of the program and view the current state of software variable and hardware registers to determine what occurred during execution.

One conventional approach of accomplishing this function involves providing a register and a multi-bit comparator. The comparator compares a multi-bit address value stored in the register with a multi-bit address value present on the address bus of the processor. The output of the comparator is a halt signal that is supplied to the processor. To set a breakpoint to stop the processor at a particular address, the user writes the address into the register. Execution of the instructions of the program is then commenced. When the processor reaches the instruction that is stored at the address value in the register, the comparator determines that the address value in the register is the same value that is on the address bus of the processor. The comparator therefore outputs the halt signal and the halt signal in turn stops the processor. An external debugging tool is commonly provided whereby the user can determine the contents of the halted processor's internal registers. This approach that uses a register and comparator is sometimes called a hardware breakpoint.

Another conventional approach to providing a breakpoint is called a software breakpoint. One of the operation codes (opcodes) of the processor is a breakpoint instruction opcode. This instruction opcode may, in some systems, be an illegal instruction that is not used in the instruction set. In other systems it is an opcode of a legitimate instruction of the instruction set that is executed by the processor. When the processor fetches this particular opcode from program memory and decodes it, the processor detects the breakpoint instruction and takes a particular action. The particular action may, for example, be to halt. In another example, the processor may jump to a particular location. In another example, the processor may signal that the processor has reached a breakpoint instruction.

To place a software breakpoint into a program that is being debugged, the user typically overwrites a particular instruction of the program code in memory with the breakpoint instruction. The processor then commences execution of the program code. When the processor fetches and decodes the breakpoint instruction, the processor halts and performs the operation to be performed by the breakpoint instruction. Again, as in the hardware breakpoint example, a debugging tool is typically used to determine the contents of the processor's internal registers or to otherwise determine the state of the system.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a functional block diagram illustrating a software architecture for managing breakpoint groups via a graphical user interface (“GUI”), in accordance with an embodiment of the invention.

FIG. 2 is a screen shot illustrating a GUI window for managing breakpoint groups and selectively viewing breakpoints assigned to each breakpoint group, in accordance with an embodiment of the invention.

FIG. 3 is a screen shot illustrating a GUI window for adding breakpoints from a list of breakpoints to a selected individual breakpoint group, in accordance with an embodiment of the invention.

FIG. 4 is a screen shot illustrating a GUI window for adding and removing a selected individual breakpoint to/from any of a list of breakpoint groups, in accordance with an embodiment of the invention.

FIG. 5 is a flow chart illustrating a process for managing breakpoint groups via a GUI, in accordance with an embodiment of the invention.

FIG. 6 illustrates a demonstrative processing system for storing and executing embodiments of the invention.

### DETAILED DESCRIPTION

Embodiments of a system and method for logically grouping breakpoints are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

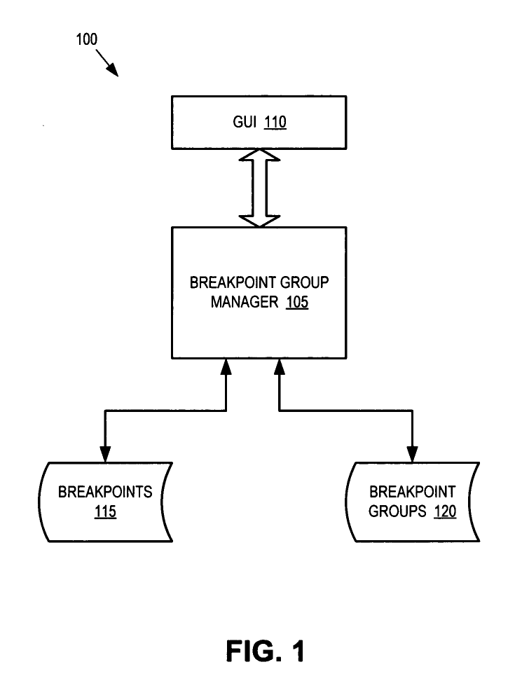

FIG. 1 is a functional block diagram illustrating a software architecture system 100 for managing breakpoint groups via a graphical user interface (“GUI”), in accordance with an embodiment of the invention. The illustrated embodiment of system 100 includes a breakpoint group manager 105, a GUI 110, a list of breakpoints 115, and a list of breakpoint groups 120. In one embodiment, system 100 represents functional blocks that may be included within a debugger tool or a software developer's workbench for developing, testing, and debugging program code.

Each breakpoint of the list of breakpoints 115 represents a pause command inserted at a selected location in a program under test to temporarily halt the program for testing and debugging. Lines in the source code of a program may be marked for breakpoints. Breakpoint instructions are then inserted into the corresponding locations of the executable code (e.g., assembly code or machine code). When the breakpoint instructions are executed, the program under test stops, allowing the programmer to examine the status of the program (registers, variables, etc.). After inspection, the programmer can step through the program one line at a time, cause the program to continue running either to the end or to the next breakpoint, whichever comes first, or stop debugging altogether in order to make code changes. Breakpoints are typically inserted just before or after critical decision points in a program and other informative locations to facilitate code tracing during development, testing, or debugging.

Breakpoint group manager 105 manages the list of breakpoints 115 and the list of breakpoint groups 120 to implement a variety of breakpoint functions. A user of system 100 may desire to group sets of breakpoints 115 for a variety of reasons based on a variety of logical relations. For example, breakpoints 115 may be grouped to test for a specified condition or circumstance. Breakpoints 115 may be grouped to test a particular program module, procedure, object, or entity of a program. Breakpoints 115 may be grouped to test for a specified use-case scenario. Breakpoint group manager 105 enables the user to customize their debugging environment for efficiency when performing iterative testing or debugging.

Breakpoint groups 120 may be created and given a descriptive name. Subsequently, breakpoints 115 may be added or assigned to breakpoint groups 120 from the list of breakpoints 115. Logical relations established by breakpoint groups 120 can then be saved into a breakpoint group file to be reused as often as desired.

Once a breakpoint group 120 has been created and one or more breakpoints 115 added to the new breakpoint group 120, the breakpoint group 120 can have an enabled or disabled status. An enabled status means that all breakpoints 115 assigned to the particular breakpoint group 120 are enabled and will halt execution of the program under test when executed. A disable status means that all breakpoints 115 assigned to the particular break point group 120 are disabled and will not halt execution. In short, breakpoint groups 120 provide a convenient mechanism to associate groups of breakpoints 115 and collectively enable or disable the grouped breakpoints.

Each breakpoint group 120 includes data members that describe the unique properties of the particular breakpoint group 120. For example, the data members may include the group name, the group enable state, an internal group identifier, and a breakpoint list identifying each breakpoint 115 added to the particular breakpoint group 120. In one embodiment, breakpoint groups 120 are implemented as objects instantiated from a group class type in the C++ programming language. When a new breakpoint group 120 is created, the group class type instantiates a new object instance. The newly created breakpoint group 120 is an empty container object ready to be filled with breakpoint handles referencing breakpoints 115. Once multiple breakpoint handles are added to the container object, the corresponding breakpoints 115 are logically grouped and can be collectively enabled or disabled via the assertion of a single command.

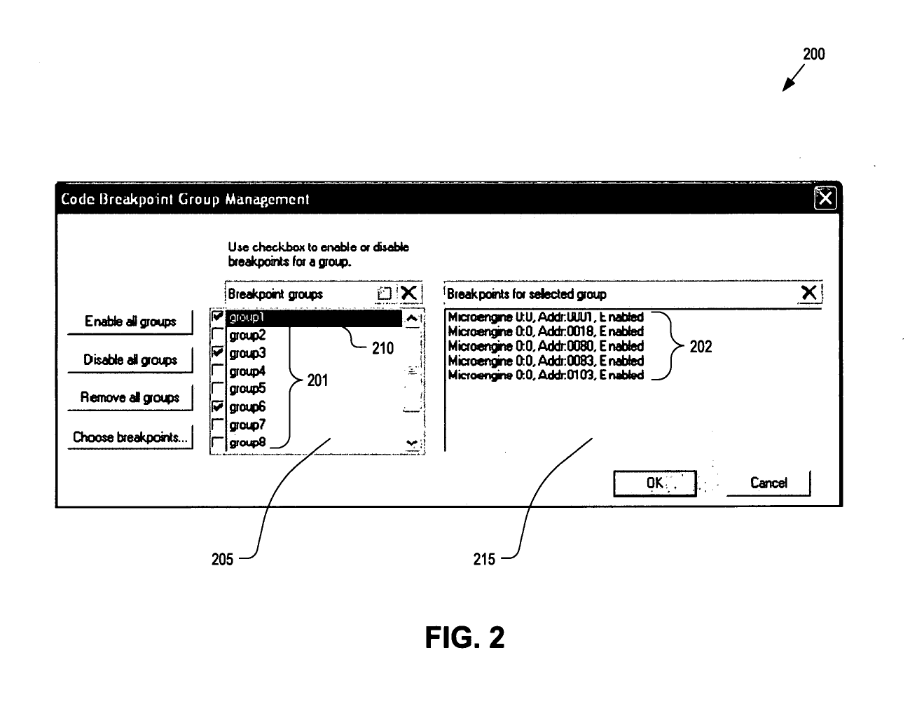

The functionality provided by breakpoint group manager 105 is visually accessible to a user of system 100 via GUI 110. This visual accessibility may be implemented using a combination of command line prompts, menus (e.g., pull down menus, popup menus, etc.), viewing panes, windows, buttons, check boxes, and the like. Examples of various visual interfaces generated by GUI 110 for accessing the functionality provided by breakpoint group manager 105 are illustrated in FIGS. 2, 3, and 4.

As mentioned, breakpoint group manager 105 manages breakpoints 110 and breakpoint groups 120. For example, breakpoint group manager 105 may be accessed via GUI 110 to create one or more breakpoint groups 120, to name and rename breakpoint groups 120, to add one or more breakpoints 115 to a particular breakpoint group 120, to delete one or more breakpoints 115 from a particular breakpoint group 120, to delete one or more breakpoint groups 120, to enable or disable one or more breakpoint groups 120, to enable or disable all breakpoint groups 120, and to save breakpoints 115 and breakpoint groups 120 to a project file for later recall.

FIG. 2 is a screen shot illustrating a GUI window 200 for managing breakpoint groups 120 and selectively viewing breakpoints 115 assigned to each breakpoint group 120, in accordance with an embodiment of the invention. GUI window 200 includes viewing pane 205 that lists all created breakpoint groups 201 associated with a particular project file. Each listed breakpoint group 201 can be selected (e.g., highlight 210) and the breakpoints 202 currently assigned to the selected breakpoint group 201 are displayed in an adjacent viewing pane 215. Breakpoints 202 displayed in viewing pane 215 may be identified via a pointer or address listing the line number in the source code where the breakpoint has been inserted. FIG. 2 illustrates breakpoints used in a network processing environment and therefore further addresses the individual breakpoints 115 by identification of a particular microengine. Viewing pane 215 further displays the enable status of each breakpoint 202.

Although FIG. 2 illustrates all breakpoints 202 of “group1” as enabled, it should be appreciated that a single breakpoint 202 can be assigned to multiple different breakpoint groups 201. Therefore, it is possible for breakpoints 202 of a single breakpoint group 201 to have different enabled status. However, by checking the checkbox to the left of each breakpoint group 201, all breakpoints 202 of the associated breakpoint group 201 can be enabled or disabled. Furthermore, the buttons to the left of viewing pane 205 provide mechanisms to enable all breakpoint groups 201, disable all breakpoint groups 201, or remove (delete) all breakpoint groups 201. It should be appreciated that deleting a breakpoint group 201 does not delete breakpoints 202 assigned to the particular breakpoint group 201, but rather merely deletes their logical association. The breakpoints remain in the list of breakpoints 115 (see FIG. 1).

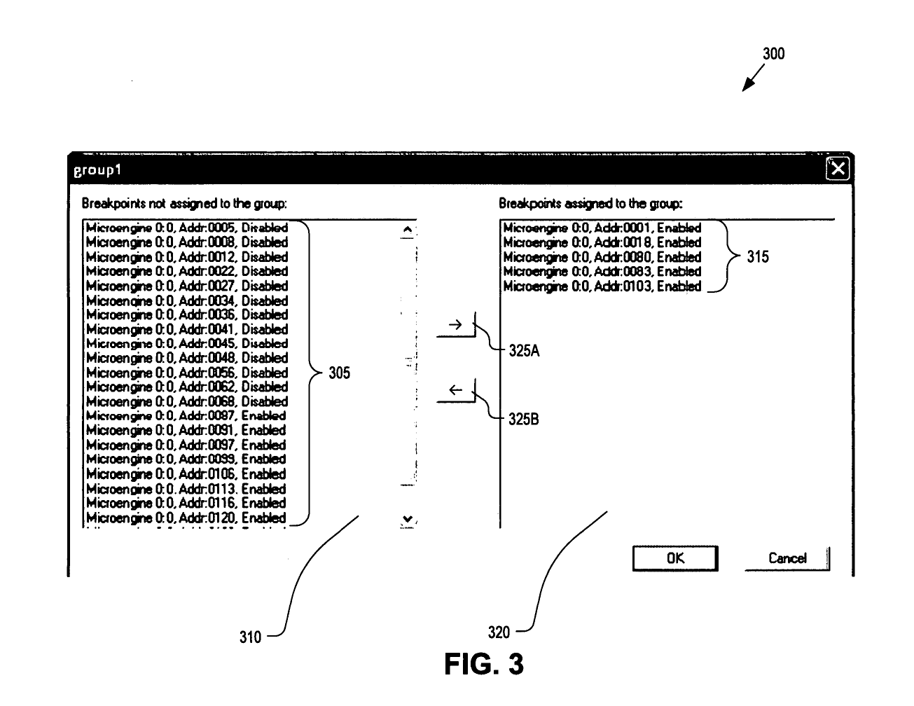

By clicking the “Choose breakpoints” button while highlighting one of breakpoint groups 201, a GUI window 300 is displayed. FIG. 3 is a screen shot illustrating GUI window 300 for adding/deleting breakpoints 202 to/from a selected breakpoint group 201, in accordance with an embodiment of the invention. GUI window 300 displays a list of breakpoints 305 in a viewing pane 310 that are not assigned to the selected breakpoint group 201. GUI window 300 further displays a list of breakpoints 315 in a viewing pave 320 that are currently assigned to the selected breakpoint group 201. Breakpoints can be added and/or deleted to the selected breakpoint group 201 via buttons 325A and 325B.

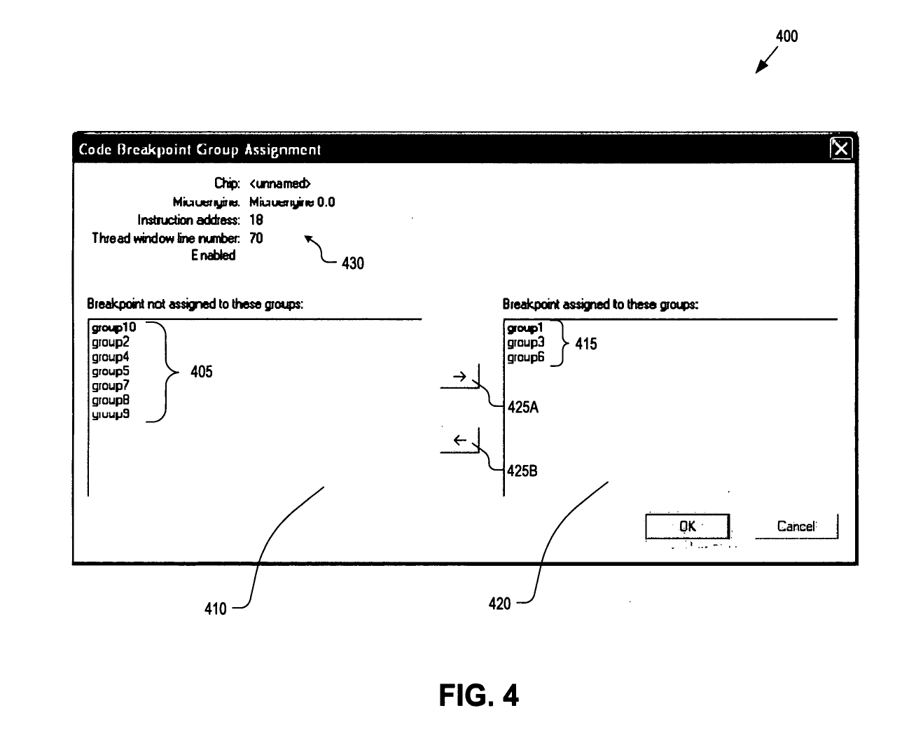

FIG. 4 is a screen shot illustrating a GUI window 400 for adding a selected individual breakpoint 115 to any of the list of breakpoint groups 120, in accordance with an embodiment of the invention. By selecting an individual breakpoint 115, GUI window 400 enables the user to add the selected breakpoint 115 to multiple breakpoint groups 120 at the same time. GUI window 400 displays a list of breakpoint groups 405 in a viewing pane 410 that do not include the selected breakpoint 115 as an assigned member. GUI window 400 further displays a list of breakpoint groups 415 in a viewing pave 420 that currently include the selected breakpoint 115 as an assigned member. The selected breakpoint 115 can be added to breakpoint groups 405 or deleted from breakpoint groups 415 via buttons 425A and 425B. GUI window 400 further displays property information 430 about the selected breakpoint 115. Property information 430 may include the name of the selected breakpoint 115, the line address of the selected breakpoint 115 within the source code, the instruction address in memory, the enable status of the selected breakpoint 115, as well as other information. Since FIG. 4 illustrates system 100 for use in a network processor environment, property information 430 includes an identification of the particular microengine.

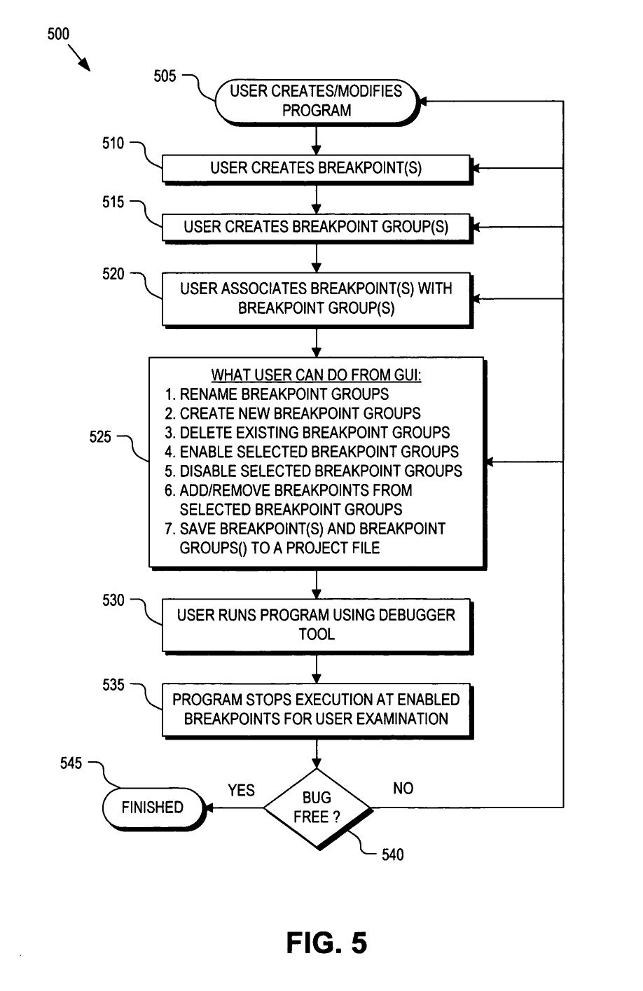

FIG. 5 is a flow chart illustrating a process 500 for managing breakpoint groups 120 via GUI 110, in accordance with an embodiment of the invention. Process 500 is described in terms of computer software and hardware. The order in which some or all of the process blocks appear in process 500 should not be deemed limiting. Rather, one of ordinary skill in the art having the benefit of the present disclosure will understand that some of the process blocks may be executed in a variety of orders not illustrated.

In a process block 505, the user creates or modifies a program under test. The program under test could include any type of program developed using a variety of software languages (e.g., C, C++, Visual Basic, Java, etc.). In a process block 510, the user creates one or more breakpoints. These created breakpoints are added to the list of breakpoints 115. In a process block 515, the user creates one or more breakpoint groups 120 using GUI 110 to interface with breakpoint group manager 105. In a process block 520, the user can then logically associate groups of breakpoints 115 by adding breakpoints 115 to breakpoint groups 120.

Once a breakpoint group 120 has been created and populated with at least one breakpoint 115, the user can perform a number of functions efficiently via GUI 110 (process block 525). For example, the user can name or rename breakpoint groups 120, create a new breakpoint group 120, delete an existing breakpoint group 120, enable selected breakpoint groups 120, disable selected breakpoint groups 120, add or remove breakpoints 115 from breakpoint groups 120, and save breakpoints 115 and breakpoint groups 120 to a project file for later use. GUI 110 and breakpoint group manager 105 enable a user to collectively enable or disable all breakpoints 115 of a single breakpoint group 120 by asserting a single command (e.g., clicking the checkboxes in viewing pane 205 (see FIG. 2).

Once the user has enabled the desired breakpoint groups 120, the program under test can be executed using a debugger tool (process block 530). When the program execution reaches one of the enabled breakpoints 115, execution of the program under test is temporarily halted, allowing the user to view internal variables or advance execution one instruction at a time (process block 535). If the program under test reaches the end of execution without error (decision block 540), then debugging is complete in a process block 545. However, if further testing is required, then the user can return to several possible stages to continue development, testing, or debugging.

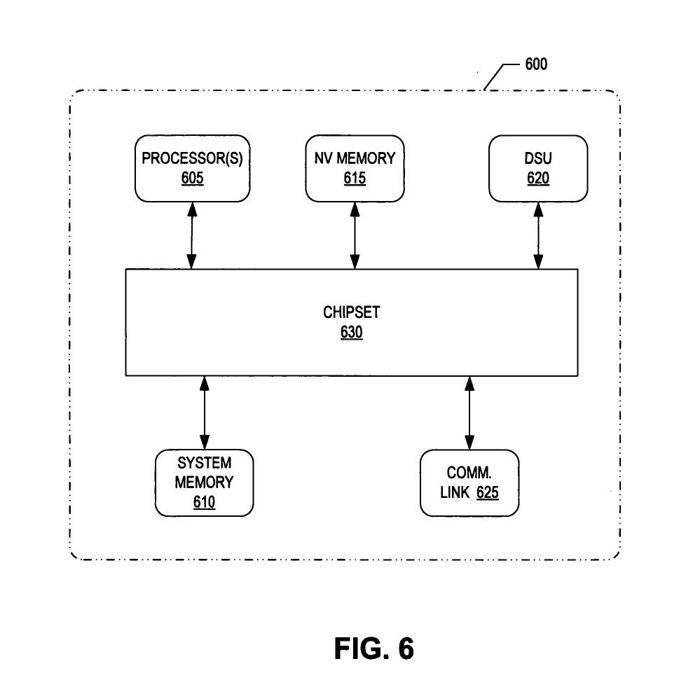

FIG. 6 is a block diagram illustrating a demonstrative processing system 600 for executing any of breakpoint group manager 105, GUI 110, and process 500. The illustrated embodiment of processing system 600 includes one or more processors (or central processing units) 605, system memory 610, nonvolatile (“NV”) memory 615, a data storage unit (“DSU”) 620, a communication link 625, and a chipset 630. The illustrated processing system 600 may represent a computing system including a desktop computer, a notebook computer, a workstation, a handheld computer, a server, a blade server, or the like.

The elements of processing system 600 are interconnected as follows. Processor(s) 605 is communicatively coupled to system memory 610, NV memory 615, DSU 620, and communication link 625, via chipset 630 to send and to receive instructions or data thereto/therefrom. In one embodiment, NV memory 615 is a flash memory device. In other embodiments, NV memory 615 includes any one of read only memory (“ROM”), programmable ROM, erasable programmable ROM, electrically erasable programmable ROM, or the like. In one embodiment, system memory 610 includes random access memory (“RAM”), such as dynamic RAM (“DRAM”), synchronous DRAM, (“SDRAM”), double data rate SDRAM (“DDR SDRAM”) static RAM (“SRAM”), and the like. DSU 620 represents any storage device for software data, applications, and/or operating systems, but will most typically be a nonvolatile storage device. DSU 620 may optionally include one or more of an integrated drive electronic (“IDE”) hard disk, an enhanced IDE (“EIDE”) hard disk, a redundant array of independent disks (“RAID”), a small computer system interface (“SCSI”) hard disk, and the like. Although DSU 620 is illustrated as internal to processing system 600, DSU 620 may be externally coupled to processing system 600. Communication link 625 may couple processing system 600 to a network such that processing system 600 may communicate over the network with one or more other computers. Communication link 625 may include a modem, an Ethernet card, a Gigabit Ethernet card, Universal Serial Bus (“USB”) port, a wireless network interface card, a fiber optic interface, or the like.

It should be appreciated that various other elements of processing system 600 have been excluded from FIG. 6 and this discussion for the purpose of clarity. For example, processing system 600 may further include a graphics card, additional DSUs, other persistent data storage devices (e.g., tape drive), and the like. Chipset 630 may also include a system bus and various other data buses for interconnecting subcomponents, such as a memory controller hub and an input/output (“I/O”) controller hub, as well as, data buses (e.g., peripheral component interconnect bus) for connecting peripheral devices to chipset 630. Moreover, processing system 600 may operate without one or more of the elements illustrated. For example, processing system 600 need not include DSU 620.

The techniques described above in connection with process 500 may constitute machine-executable instructions embodied within a machine (e.g., computer) accessible medium, which when executed by a machine will cause the machine to perform the operations described herein. Additionally, the processes may be embodied within hardware, such as an application specific integrated circuit (“ASIC”) or the like. A machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM); random access memory (RAM); magnetic disk storage media; optical storage media; flash memory devices; etc.), as well as electrical, optical, acoustical or other form of propagated signals (e.g., carrier waves, infrared signals, digital signals, etc.); etc.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method, comprising:
creating a plurality of breakpoints for halting execution of a program;
creating a breakpoint group for logically associating one or more of the breakpoints;
adding a portion of the breakpoints to the breakpoint group, wherein the portion includes two or more of the plurality of breakpoints; and
collectively enabling the portion of the breakpoints prior to executing the program by asserting an enable group command associated with the breakpoint group.

2. The method of claim 1, further comprising:
collectively disabling the portion of the breakpoints by asserting a disable group command associated with the breakpoint group, wherein the portion of the breakpoints is less than all of the plurality of breakpoints.

3. The method of claim 1, wherein creating the breakpoint group, adding the portion of the breakpoints to the breakpoint group, and collectively enabling the portion of the breakpoints are facilitated via a graphical user interface of a debugger tool, and the method further comprising:
executing the program with the debugger tool; and
pausing execution of the program whenever execution reaches one of the enabled breakpoints of the breakpoint group.

4. The method of claim 3, further comprising:
creating multiple breakpoint groups for logically associating one or more of the breakpoints;
adding at least some of the breakpoints to the multiple breakpoint groups, wherein each one of the multiple breakpoint groups includes a different set of at least two of the breakpoints after the adding; and
selectively enabling all breakpoints logically grouped within selective ones of the multiple breakpoint groups by asserting enable commands associated with the selective ones of the multiple breakpoint groups.

5. The method of claim 4, further comprising saving the multiple breakpoint groups and logical associations between the breakpoints and the multiple breakpoint groups to a file for later use by the debugger tool.

6. The method of claim 4, further comprising selectively naming the multiple breakpoint groups.

7. The method of claim 1, wherein at least some of the portion of the breakpoints added to the breakpoint group reference noncontiguous portions of the program in memory.

8. A system, comprising:
a processor to execute instructions,
synchronous dynamic random access memory (“SDRAM”) coupled to the processor to store the instructions; and
a data storage unit (“DSU”) coupled to the processor and storing a debugger program, the debugger program including:
a breakpoint group manager to logically group a list of breakpoints into breakpoint groups, the breakpoints each to pause execution of a program under test by the debugger program, the breakpoint group manager configured to collectively enable all of the breakpoints associated with each individual one of the breakpoint groups with a single user command.

9. The system of claim 8, wherein the debugger program further includes a graphical user interface (“GUI”) communicatively interfaced with the breakpoint group manger to facilitate a user of the debugger program to collectively enable all of the breakpoints logically associated with each of the breakpoint groups by asserting an enable group command associated with each of the one or more breakpoint groups.

10. The system of claim 9, wherein the debugger program further includes a breakpoint group folder, the breakpoint group folder for storing the one or more breakpoint groups.

11. The system of claim 9, wherein the graphical user interface further includes:
an enable all groups command to selectively enable the breakpoints logically associated with all of the one or more breakpoint groups;
a disable all groups command to selectively disable the breakpoints logically associated with all of the one or more breakpoint groups; and
a remove all groups command to selectively remove all of the breakpoint groups.

12. The system of claim 11, wherein the graphical user interface further includes a GUI window for selecting one of the breakpoint groups displayed in a first viewing pane and displaying the breakpoints logically assigned to the selected one of the breakpoint groups in a second viewing pane.

13. The system of claim 9, wherein the graphical user interface further includes a GUI window for adding one or more of the breakpoints from the list of breakpoints to a selected one of the breakpoint groups.

14. The system of claim 9, wherein the graphical user interface further includes a GUI window for adding a selected breakpoint from the list of breakpoints to one or more of the breakpoint groups.

15. A machine-accessible medium that provides instructions that, if executed by a machine, will cause the machine to perform operations comprising:
enabling creation of a plurality of breakpoints for stopping execution of a program;
enabling creation of a breakpoint group for logically associating one or more of the breakpoints;
enabling addition of a portion of the breakpoints to the breakpoint group, wherein the portion includes two or more of the plurality of breakpoints; and
enabling collective enablement of the portion of the breakpoints prior to executing the program by asserting an enable group command associated with the breakpoint group.

16. The machine-accessible medium of claim 15, further providing instructions that, if executed by the machine, will cause the machine to perform further operations, comprising:
enabling collective disablement of the portion of the breakpoints by asserting a disable group command associated with the breakpoint group, wherein the portion of the breakpoints is less than all of the plurality of breakpoints.

17. The machine-accessible medium of claim 15, wherein enabling creation of the breakpoint group, addition of the portion of the breakpoints to the breakpoint group, and collective enablement of the portion of the breakpoints are facilitated via a graphical user interface of a debugger tool, and further providing instructions that, if executed by the machine, will cause the machine to perform further operations, comprising:
executing the program with the debugger tool; and
pausing execution of the program whenever execution reaches one of the enabled breakpoints of the breakpoint group.

18. The machine-accessible medium of claim 17, further providing instructions that, if executed by the machine, will cause the machine to perform further operations, comprising:
creating multiple breakpoint groups for logically associating one or more of the breakpoints;
adding at least some of the breakpoints to the multiple breakpoint groups, wherein each one of the multiple breakpoint groups includes a different set of at least two of the breakpoints after the adding; and
selectively enabling all breakpoints logically grouped within selective ones of the multiple breakpoint groups by asserting enable commands associated with the selective ones of the multiple breakpoint groups.

19. The machine-accessible medium of claim 18, further providing instructions that, if executed by the machine, will cause the machine to perform further operations, comprising:
saving the multiple breakpoint groups and logical associations between the breakpoints and the multiple breakpoint groups to a file for later use by the debugger tool.

20. The machine-accessible medium of claim 18, further providing instructions that, if executed by the machine, will cause the machine to perform further operations, comprising:
selectively naming the multiple breakpoint groups.
